(19) United States
(12) Patent Application Publication
(10) Pub. No.: US 2011/0234796 A1
(43) Pub. Date: Sep. 29, 2011

(54) System and Method for Automatically Merging Imagery to Provide Enhanced Situational Awareness

(75) Inventor: James E. Taber, Garland, TX (US)

(73) Assignee: Raytheon Company, Waltham, MA (US)

(21) Appl. No.: 12/748,693

(22) Filed: Mar. 29, 2010

(51) Int. Cl. H04N 9/76; H04N 7/18

(52) U.S. Cl. 348/144; 348/598; 348/E07.085; 348/E09.057

(57) ABSTRACT

The system relates to a method for merging surveillance imagery to provide enhanced situational awareness. In one aspect of the method, near real time video from an unmanned aerial done is merged with existing imagery from a database. The method also contemplates writing the merged images into a Keyhole Markup Language (KML) Zip (KMZ) file to permit the merged images to be viewed by an Earth browser.

### TECHNICAL FIELD

This disclosure relates to a system and method for merging image data. More specifically, the disclosure relates to a method for merging surveillance imagery from different sources to provide for increased situational awareness.

### BACKGROUND OF THE INVENTION

A wide variety of surveillance activities rely upon collecting and processing image data. The image data can take the form of static images or video. This surveillance can be carried out by aircraft, satellites, waterborne vehicles, or from ground based assets. Whatever the source, the collected imagery is ideally processed in real time, or near real time, in order to support timely tactical or long-term strategic decision making.

For example, reconnaissance aircraft, such as unmanned aerial vehicles (or “UAVs”), can provide ground based operators access to full motion video in near real time. Based upon this video feed the ground based operators must often make important tactical decisions. These decisions may include whether to engage the offensive weapons of the aircraft or to launch a strike from affiliated air or ground based forces. Significant intelligence determinations must also be made on the basis of the video provided from such reconnaissance aircraft.

Surveillance video, although benefiting from being taken in real time, or near real time, has typically suffered from a narrow field of view. Namely, in order to yield a sufficiently detailed picture, the area framed by the video must be reasonably small. As a result, surveillance video often lacks context. Although such video yields an accurate picture of a particular frame of reference, it does so at the expense of the objects, individuals, and geographic features outside of the immediate area being surveilled.

Thus, there exists a need in the art to provide images with sufficient detail but with a broadened area view to thereby increase situational awareness. There also exists a need in the art to improve current image discovery, analysis, and distribution applications and, thereby, make such applications less cumbersome and time-consuming and more tactically relevant.

### SUMMARY OF THE INVENTION

The system disclosed herein is an automated method for merging reconnaissance imagery. In one aspect of the method, near real time video from a reconnaissance aircraft is merged with existing imagery from a database. The method also contemplates writing the merged images into a Keyhole Markup Language (KML) zip (KMZ) file to permit the merged images to be viewed by an Earth browser.

The disclosed system has the advantage of providing a detailed near real time image from surveillance video while at the same time putting the video image in a larger context by way of existing images.

A further advantage is found in associating merged images with a KMZ file to permit the merged images to be viewed in the even larger context of an Earth browser.

Still yet another advantage is to employ the geocoding of an image to locate other geographically relevant images and merge a number of different overlapping or partially overlapping images.

Another advantage is to provide a fully automated system whereby overlapping images are located and merged via a software application after a frame of interest is captured from a surveillance video.

Yet another advantage is to create images with sufficient detail but with a broadened area view to thereby increase situational awareness.

Another advantage is to improve current image discovery, analysis, and distribution applications and, thereby, make such applications less cumbersome and time-consuming and more tactically relevant.

Yet another advantage is to use the geocoding data from the images to find and geo-spatially overlay associated information of interest.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description. The foregoing has outlined rather broadly some of the more pertinent and important advantages of the present disclosure in order that the detailed description of the disclosure that follows may be better understood so that the present contribution to the art can be more fully appreciated. It should be appreciated by those skilled in the art that the conception and the specific embodiment disclosed may be readily utilized as a basis for modifying or designing other structures for carrying out the same purposes of the present disclosure. It should also be realized by those skilled in the art that such equivalent constructions do not depart from the spirit and scope of the present disclosure as set forth in the appended claims.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a block diagram illustrating various features of the disclosed system.

FIG. 2 is a block diagram illustrating an alternative embodiment of the disclosed system.

FIG. 3 is an illustration of a video frame being aligned with a number of preexisting images.

FIG. 4 is an illustration of the merged image from FIG. 3 being viewed in an Earth browser.

FIG. 5 is a flow chart illustrating the steps of the disclosed system.

### DETAILED DESCRIPTION OF THE DRAWINGS

The disclosed system relates to a system and method for merging surveillance imagery to provide enhanced situational awareness. In one aspect of the method, near real time video from an unmanned aerial drone is merged with existing imagery from a database. The method also contemplates writing the merged images into a Keyhole Markup Language (KML) Zip (KMZ) file to permit the merged images to be viewed by an Earth browser. Details regarding the system and associated method are discussed below.

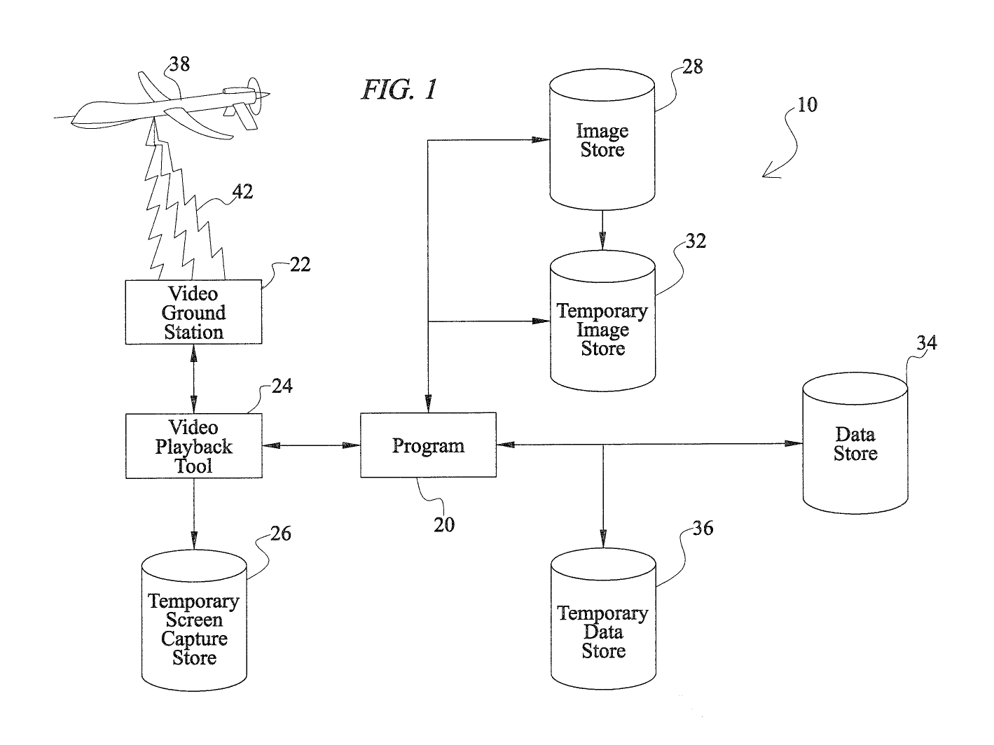

One embodiment of the disclosed system is illustrated in FIG. 1. The system 10 utilizes a program 20 running on one or more computers. As used in this document, the term “computer” is intended to encompass a personal computer, workstation, network computer, smart phone, or any other suitable processing device. Program 20 can be written in any appropriate computer language such as, for example, C, C++, Assembler, Java, Visual Basic, and others or any combination thereof. As noted in FIG. 1, program 20 interfaces with a video ground station 22, via a video playback tool 24, as well as a variety of data stores. These stores include a temporary data store 36, an image store 28, a temporary image store 32, and a data store 34. Program 20 also interfaces with a temporary screen capture store 26 via the video playback tool 24. These stores can be hard drives, or other fixed or removable storage media, such as optical or magnetic based media. The stores can be local to the ground station 22 or can be remotely distributed via a computer network. Alternatively, the stores can represent files, directories, or partitions within a single storage media.

FIG. 1 also shows system 10 being used in connection with an unmanned aerial vehicle, or “UAV.” The unmanned aerial vehicle 38 can be, for example, the MQ-1 Predator, the RQ-4 Global Hawk, or the MQ-8B Fire Scout. One common characteristic of these UAV is that they include a camera or series of cameras for overhead surveillance. These cameras can be gimbaled nose cameras capable of taking visual, infrared, or near infrared video. The video is transmitted to video ground station 22 for review by a remote UAV operator. As is known in the art, this video can be transmitted to ground station 22 via a data link 42, which can be a C-band line-of-sight data link or a Ku-band satellite data link for beyond-line-of-sight operations.

Although UAV 38 is disclosed in the embodiment of FIG. 1, the disclosed system 10 can just as easily be carried out in connection with other types of aerial vehicles, both manned and unmanned. The system can also be used in conjunction with spaced-based vehicles, such as satellites or other spacecraft. Land based and waterborne surveillance can also benefit from the present system. Those of ordinary skill in the art will appreciate that the steps involved in the disclosed method can be employed with any type of surveillance imagery regardless of whether the source is manned or unmanned, land, air, water, or space based.

Returning now to FIG. 1, UAV 38 generates an overhead full-motion video stream. The UAV operator at video ground station 22 monitors the video stream generated by the airborne camera. The video can be monitored, for example, by way of video playback tool 24. Playback tool 24 can be either local to or remote from the ground station 22. Depending upon the distance between UAV 38 and ground station 22, the video may be provided near real time. The delay may be as much as 1-2 seconds in some instances. In the event ground station 22 is in the general proximity of UAV 38, the video can be viewed in real time.

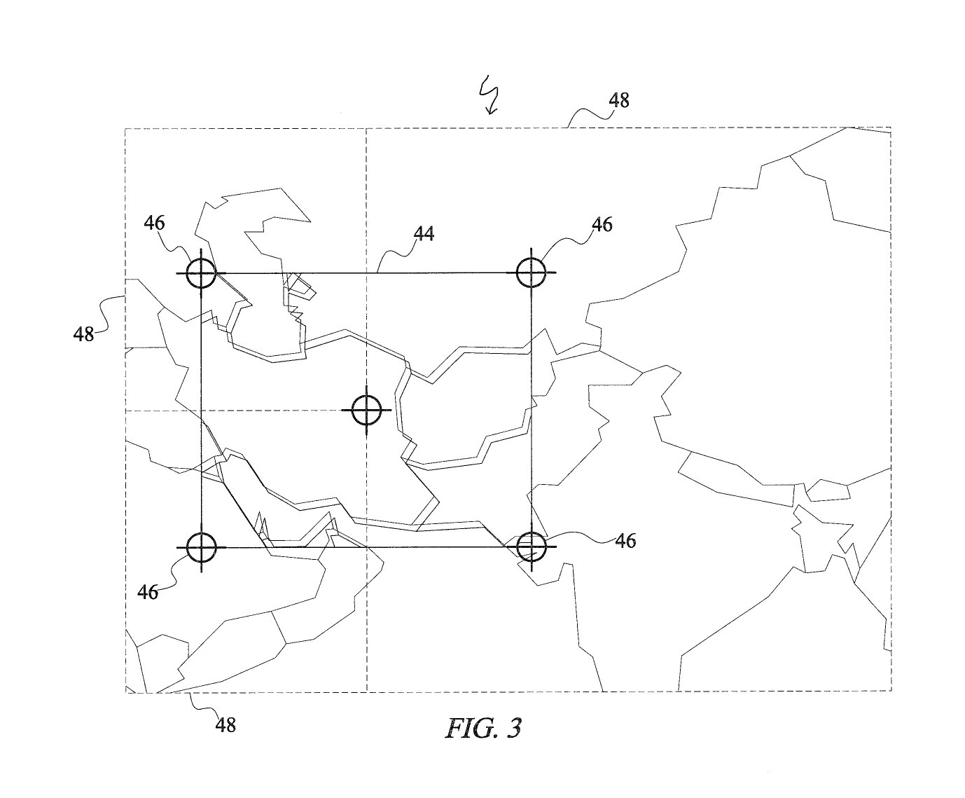

In the context of a military operation, the UAV operator may be looking for targets of interest, such as individuals, ground based military equipment, troop formations, moving vehicles, or bunkers. Once a target of interest is located the user utilizes video playback tool 24 to capture a particular frame of interest 44 (note FIG. 3). Once the frame is isolated and captured it is stored for subsequent retrieval and processing. In the disclosed method, the captured video frame 44 is stored in temporary screen capture store 26. A variety of image formats can be used for storing frame 44 depending upon the image analysis requirements. Some possible formats include the National Imagery Transmission Format (NITF) and Joint Photographic Experts Group (JPEG) format.

In addition to the captured frame 44, metadata associated with captured frame 44 is also stored in the temporary screen capture store 26. This metadata can include, for example, time and date stamps and geocoding. The geocoding can be the geographic latitude, longitude, and elevation for each of the four corners 46 of the image, as well as other desired reference points, such as the center of the image (note FIG. 3). The geocoding should be sufficient to describe the complete geographic footprint of the captured frame 44 relative to the Earth's surface. The geocoding can be automatically generated along with the image, or it can be manually entered after the image is generated. Suitable formats for the geocoding can include latitude and longitude in degrees, minutes and seconds or other formats, such as the Military Grid Reference System (MGRS) or decimal degrees.

Program 20 detects when the captured frame 44 and its metadata are saved to screen capture store 26. Thereafter, the geocoding associated with captured frame 44 is extracted. The program then queries image store 28 on the basis of the extracted geocoding. Image store 28 can be a catalogue of previously generated satellite imagery, or it can be previous aerial imagery taken from either manned or unmanned aircraft. The images within store 28 likewise include associated geocoding. Thus, program 20 compares the geocoding from captured frame 44 to the geocoding associated with the images within image store 28. The query returns any geographically overlapping images. The query initially returns a list of candidate imagery that includes any image that either partially or completely overlaps with captured frame 44. Depending upon the geographic area in question and the completeness of the image store, numerous candidate images may be returned. Criteria can be established to select certain images from the candidate images. In one example, program 20 uses predetermined criteria to remove redundant or otherwise inadequate images from the candidate images. The remaining images, or the located images, 48 are then sent to temporary image store 32. The arrival of the located images 48 in temporary image store 32 is detected by program 20. Thereafter, program 20 detects the captured frame in temporary image store 32 and moves both located images 48 and captured frame 44 into temporary data store 36.

Program 20 then orients captured frame 44 over top of the located images 48 to create a single merged image 52 (note FIG. 3). Merged image 52 is comprised of the located still images 48 constituting an underlying base layer and the captured frame 44 constituting a top layer. The respective geocoding is used to properly orient the images 44 and 48 with respect to one another. This involves aligning two or more coordinates in overlapping images, or aligning one coordinate along with an angular reference to North or South. The transparency of the layers can be modified as necessary to highlight underlying geographic features of interest. The merged image 52 permits analysis of captured frame 44 within the context of the larger existing imagery 48. This, in turn, provides the operator with enhanced situational awareness. The merged image 52 can be stored in a JPEG format to speed processing and secondary product creation.

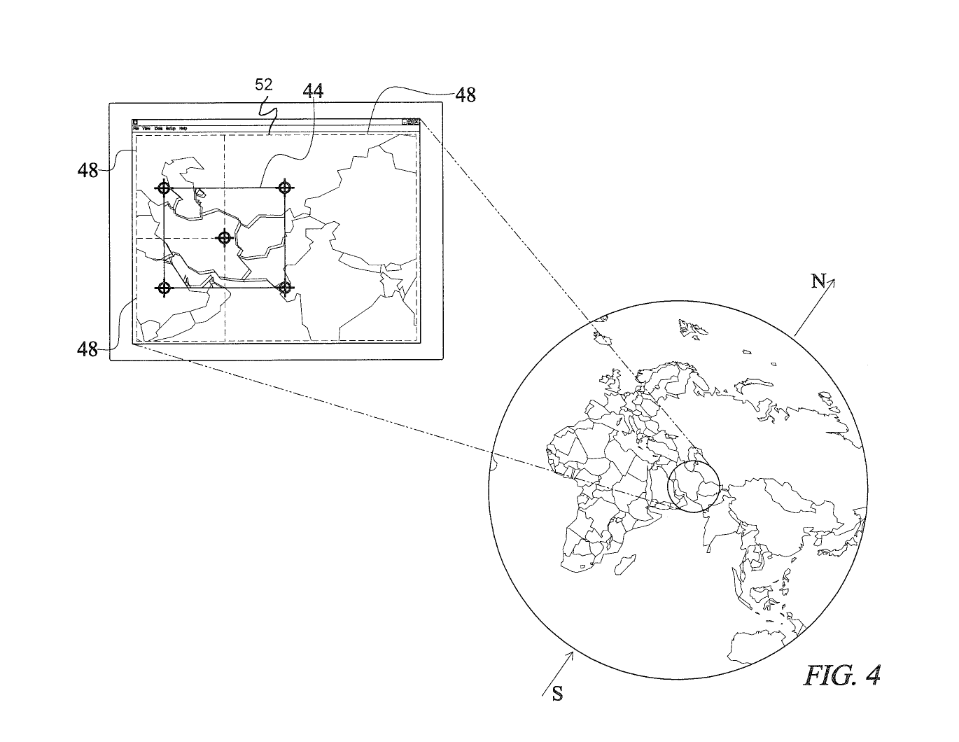

Still yet additional situational awareness can be achieved by permitting the merged image 52 to be viewed in an Earth browser, such as Google Earth®. This includes, inter alia, desktop, intranet and Internet based Earth browsers along with smart-phone based earth browsers. In order to facilitate such viewing, a Keyhole Markup Language (KML) Zip (KMZ) file is written to temporary data store 36. KML is an XML-based language that is based upon an open standard defined by The Open Geospatial Consortium, Inc.® (www.opengeospatial.org). The encoding provided by KML, as part of a larger KMZ file, permits features, such as images, to be displayed in an Earth browser, or geobrowser (note FIG. 4). Still yet other formats beyond KML and KMZ can be employed.

In accordance with the disclosed method, one or more metadata markers can be associated with the KML file. These markers can be, for example, annotations or placemarks that are generated by the UAV operator or analyst. These metadata markers are then compressed along with the captured frame and located imagery into the KMZ file. The KMZ file is thereafter moved to a separate data store 34 for access by a conventional Internet-based Earth browser.

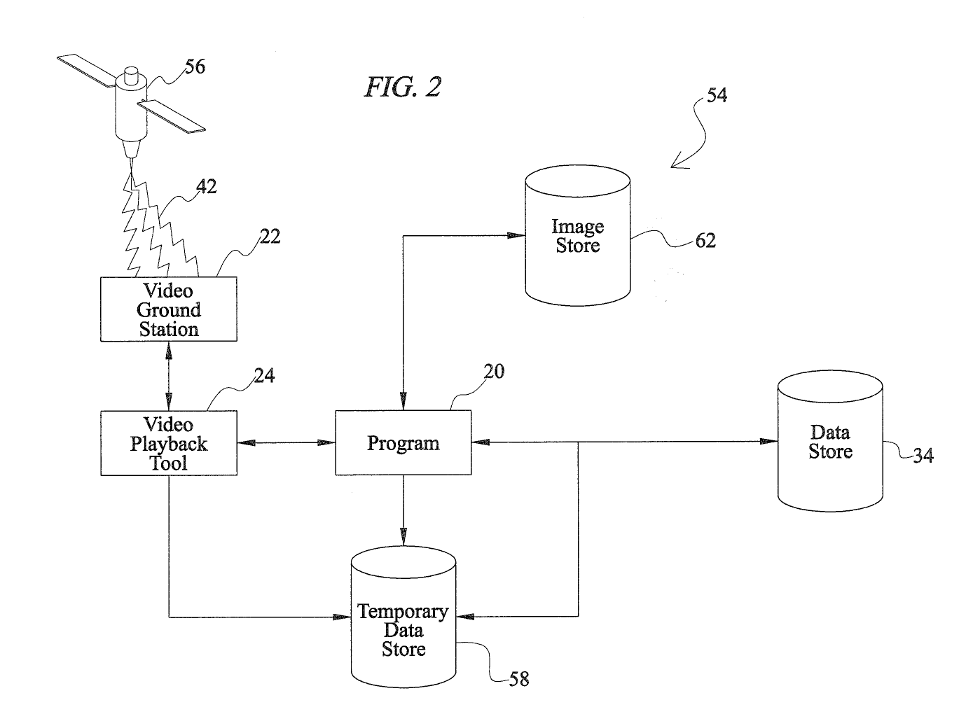

An alternative embodiment of the disclosed system is illustrated with reference to FIG. 2. This alternative system 54 is the same in most respects to the system 10 disclosed in FIG. 1. However, in this embodiment, the video feed is generated by a space based satellite 56 instead of a surveillance aircraft. In still yet a further embodiment, land based surveillance equipment, such as long range cameras, are used to replace the satellite. In yet another embodiment, waterborne surveillance equipment, such as mast cameras, are used to replace the satellite. In the embodiment of FIG. 2, temporary screen capture store 26 and temporary data store 36 (note FIG. 1) have been combined into a single temporary data store 58 (note FIG. 2). This data store 58 can be resident within video ground station 22 or it can be remotely located. Additionally, image store 28 and temporary image store 32 from system 10 are combined into a single image store 62. Again, this store can be accessed either locally or remotely. Still yet various other data store configurations may be utilized and are contemplated by the present system.

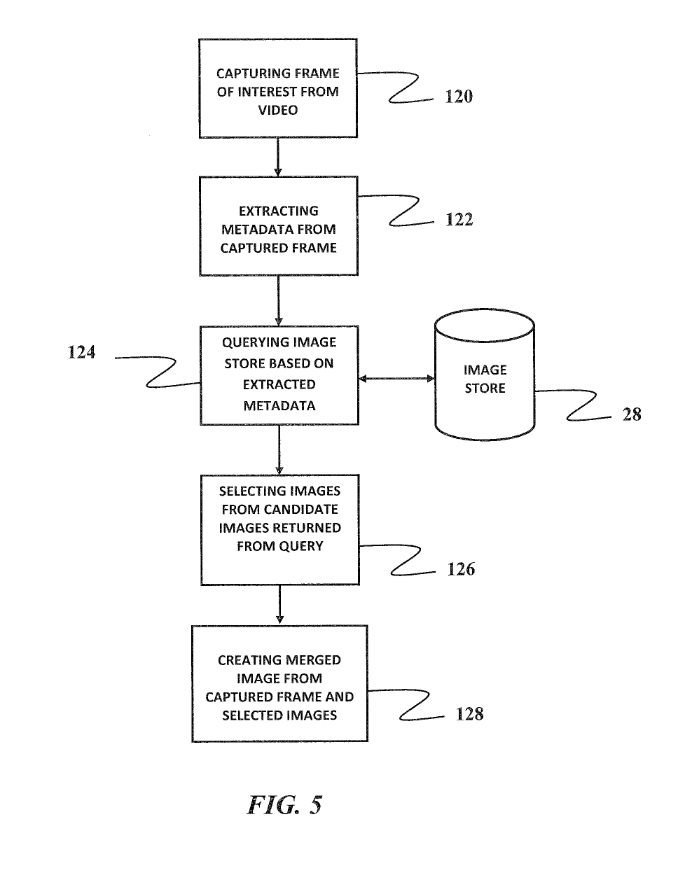

The steps carried out in connection with the disclosed system are sequentially described in conjunction with the flow chart of FIG. 5. In the first step 120, a frame of interest is captured from the video. Frame 44 may have metadata associated with it, or relevant metadata may be manually inserted by a computer or human operator. The frame of interest and associated metadata are then stored for subsequent retrieval by program 20. At step 122, program 20 extracts the metadata from captured frame 44. In one particular embodiment, the metadata may take the form of spatial coordinates. Thereafter, at step 124 program 20 queries image store 28 on the basis of the extracted metadata. Based upon the query, a list of geographically relevant candidate images are located. Images are selected from the candidate images at step 126, with the selection being based upon any of a variety of criteria. For example, in one embodiment, the selection may be based upon criteria such as those images having the greatest amount of overlap. Finally, at step 128, the captured frame is oriented over the selected images 48 to create a final merged image.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for merging imagery from different aerial sources, one source being a camera mounted within an aerial vehicle, wherein the camera is in communication with a ground station to provide near real time video to an operator, another source being a store of existing imagery, the method permitting the merged imagery to be viewed in an Earth browser, the method comprising:
generating a video stream from the camera within the aerial vehicle, the video stream including associated geocoding, transmitting the video stream and associated geocoding to the ground station for review by the operator;
capturing a frame of interest from the generated video stream;
storing the frame of interest and associated geocoding in a temporary screen capture store;
extracting the geocoding associated with the frame of interest;
querying the store of existing imagery based upon the extracted geocoding and locating one or more images based upon the query;
storing the located imagery in a temporary image store;
moving the captured frame and located imagery to a temporary data store and orienting the captured frame over the located imagery;
writing a Keyhole Markup Language (KML) Zip (KMZ) file to the temporary data store to permit the captured frame and located imagery to be viewed by the Earth browser.

2. A method for merging imagery from different sources, one source being a camera providing images to an operator in real time or near real time, another source being a store of existing imagery, the method comprising:
generating an image of interest and associated geocoding;
extracting the associated geocoding from the image of interest;
querying the store of existing imagery based upon the extracted geocoding and locating one or more images based upon the query;
creating a merged image by orienting the image of interest over the located imagery.

3. The method as described in claim 2 wherein the method further comprises:
creating a Keyhole Markup Language (KML) Zip (KMZ) file from the merged image for viewing by an Earth browser.

4. The method as described in claim 3 wherein the method further comprises:
associating one or more metadata markers with the KML file; and
compressing the metadata markers and the merged image into a KMZ file;
permitting access to the KMZ file via the Earth browser.

5. The method as described in claim 2 wherein the camera is a video camera mounted on an aerial vehicle.

6. The method as described in claim 2 wherein the image of interest is provided by a satellite.

7. The method as described in claim 2 wherein the image of interest is provided by a ground based camera.

8. The method as described in claim 2 wherein the image of interest is provided by a waterborne based camera.

9. A method for merging imagery from different sources, the method comprising:
generating video in real time or near real time via a camera and capturing a frame of interest from the generated video, wherein metadata is associated with the frame of interest;
providing a store of previously generated imagery;
extracting the associated metadata from the frame of interest;
querying the store of previously generated imagery based upon the metadata and selecting one or more images based upon the query;
creating a merged image by orienting the frame of interest over the selected imagery.

10. The method as described in claim 9 wherein the method further comprises:
creating a Keyhole Markup Language (KML) file from the merged image for facilitating viewing by an Earth browser.

11. The method as described in claim 9 wherein the generated video, store of previously generated imagery, frame of interest and merged image are distributed across a computer network.

12. A system for merging imagery from different sources, the system comprising:
a camera for generating video in real time or near real time;
a video playback tool for capturing a frame of interest from the generated video, wherein geocoding is associated with the frame of interest;
a data store containing previously generated images and associated geocoding;
a computer operating to select one or more images from the data store by comparing the geocoding from the frame of interest to the geocoding of the previously generated images;
the computer thereafter creating a merged image by orienting the frame of interest over the selected images.

13. The system as described in claim 12 wherein the camera is associated with an unmanned aerial vehicle.

14. The system as described in claim 12 wherein the camera is associated with a manned aerial vehicle.

15. The system as described in claim 12 wherein the camera is associated with a satellite.

16. The system as described in claim 12 wherein the camera is associated with a land based reconnaissance vehicle.

17. The system as described in claim 12 wherein the camera is associated with an unmanned ground sensor.

18. The system as described in claim 12 wherein the camera is associated with a manned ground sensor.

19. The system as described in claim 12 wherein the camera is associated with an unmanned waterborne sensor.

20. The system as described in claim 12 wherein the camera is associated with a manned waterborne vehicle.

21. The system as described in claim 2 wherein the geocoding associated with the image is inserted manually by a user.
